(19) United States
(12) Patent Application Publication
(10) Pub. No.: US 2025/0250679 A1
(43) Pub. Date: Aug. 7, 2025

(54) METHODS FOR PREPARING AND USING AT LEAST ONE PROTECTIVE COATING ON INDUSTRIAL COMPONENTS AND STORAGE SYSTEMS

(71) Applicant: North Carolina State University, Raleigh, NC (US)

(72) Inventors: Ge Yang, Cary, NC (US); Da Cao, Raleigh, NC (US); Mohamed Abdelhay Bourham, Raleigh, NC (US)

(21) Appl. No.: 19/047,338

(22) Filed: Feb. 6, 2025

Related U.S. Application Data
(60) Provisional application No. 63/550,522, filed on Feb. 6, 2024.

(51) Int. Cl. C23C 18/12; B65D 25/14; C04B 35/571; C23C 18/04; G21F 9/36

(52) U.S. Cl. CPC C23C 18/122; B65D 25/14; C04B 35/571; C23C 18/04; C23C 18/1241; C23C 18/1262; C23C 18/1291; C23C 18/1295; G21F 9/36; C04B 2235/483

(57) ABSTRACT

Methods for preparing and using at least one protective coating on industrial articles and storage systems are disclosed. In one example, the industrial components are dry storage cannisters for spent nuclear fuel or other waste materials. An example method for preparing at least one protective coating on dry storage cannisters for spent nuclear fuel and waste includes dissolving a dispersant in an organic solvent. The method further includes adding a polymer-derived ceramic (PDC) to the organic solvent and dissolved dispersant to create a pre-ceramic solution. The method further includes applying the pre-ceramic solution on a metal and/or alloy of industrial articles and storage systems such as the dry storage cannisters.

### PRIORITY CLAIM

This application claims the priority benefit of U.S. Provisional Patent Application Ser. No. 63/550,522 filed Feb. 6, 2024, the disclosure of which is incorporated herein by reference in its entirety.

### GOVERNMENT INTEREST

This invention was made with government support under DE-NE0008944 awarded by the U.S. Department of Energy. The government has certain rights in the invention.

### TECHNICAL FIELD

The subject matter described herein relates to protective coatings for extending service lifetime of metal and alloy materials and components. More particularly, the subject matter described herein relates to methods for preparing and using at least one protective coating on industrial components and storage systems, including dry storage cannisters for spent nuclear fuel and other waste materials.

### BACKGROUND

There are over 430 commercial reactors in 32 countries that provide nearly 10% of the world's electricity. In the United States, about 86000 metric tons of spent nuclear fuel are stored in on-site casks at power plants and offsite facilities (less than 1%) around the country. Even though at least 90% of its potential energy still remains, spent nuclear fuel is currently not reprocessed in the US. Consequently, proper disposal and storage of these spent nuclear fuel is a daunting and significant challenge. The spent nuclear fuel exhibits high radioactivity and decay heat, which pose health risks to humans and the environment. For example, high-level waste (HLW), including spent nuclear fuel, accounts for over 95% of the total radioactivity produced in the nuclear power process. Dry storage casks/canisters (DSCs) allow the already-cooled spent nuclear fuel to be surrounded by inert gas inside a cask/canister container. These casks/canisters are steel (e.g., SS316, SS304 etc.) based cylinders that are welded or bolted closed. Each cylinder should be surrounded by extra steel, concrete, or other materials. These shielding layers play a significant role in protecting the public and plant workers from radiation hazards. However, the structural integrity of the steel canister could be compromised due to the surrounding salt-containing environment. They are also threatened by the decay heat and radiation sources from the internal nuclear fuel waste. When considering the failure mechanisms of steel under such harsh conditions, chloride-induced stress corrosion cracking (CISCC) is one of the most important issues, since a layer of continuous deliquescent salt moisture can form and remain on the surface of steel.

CISCC has been considered a potential safety concern for long-term use of welded steel canisters. Even though no CISCC has been observed in the limited investigation of some existing steel canisters in the storage sites, the Department of Energy (DOE), the Nuclear Regulatory Commission (NRC), as well as other institutes, are working on improving their understanding of the CISCC mechanism and developing techniques to effectively detect CISCC in DSCs. Techniques are also under development to mitigate or even eliminate CISCC. Hence, to extend the service life of DSCs, CISCC is one of the major problems that needs to be solved soon. There is an urgent need for efficient and functional coating(s) that protect steel canisters from CISCC and other aggressive environmental factors. Overall, the coating system is expected to be corrosion resistant, adhesive to the substrate, cost-effective, excellent in mechanical performance, and environmentally friendly. In addition to improving alloy composition, some processing methods have been proposed to increase the lifetime of stainless steels by introducing compressive residual stress to offset tensile stress, e.g., shot peening, laser peening, and buffing. However, these techniques produce either permanent deformation of the surface layer or plastic deformation of the coating particles.

Accordingly, in light of these and other difficulties, there exists a need for improved methods for protecting industrial articles, including steel canisters, from corrosion and other environment-related damages.

### SUMMARY

Methods for preparing and using at least one protective coating on industrial articles and storage systems are disclosed. In one example, the industrial components are dry storage cannisters for spent nuclear fuel or other waste materials. An example method for preparing at least one protective coating on dry storage cannisters for spent nuclear fuel and waste includes dissolving a dispersant in an organic solvent. The method further includes adding a polymer-derived ceramic (PDC) to the organic solvent and dissolved dispersant to create a pre-ceramic solution. The method further includes applying the pre-ceramic solution on a metal and/or alloy of industrial articles and storage systems such as the dry storage cannisters.

According to another aspect of the subject matter described herein, the method further includes adding one or more metal oxides to the organic solvent and dissolved dispersant.

According to another aspect of the method described herein, the metal oxides include zirconium oxide, aluminum oxide, titanium oxide, and/or iron oxide including nanoparticles and/or microparticles.

According to another aspect of the subject matter described herein, the method further includes adding one or more passive fillers, active fillers, and/or glass or sacrificial fillers including nanoparticles and/or microparticles to the organic solvent and dissolved dispersant.

Passive fillers are chemically inert within a ceramic coating system, maintaining their composition, mass, and particle size (aside from thermal expansion) during processing and application.

During pyrolysis, organic polymers degrade, glasses may melt, and metals can oxidize. Since passive fillers do not undergo chemical reactions, they are typically ceramic materials such as SiC, Si₃N₄, ZrO₂, TiO₂, BN, Al₂O₃, and SiO₂. These materials exhibit high thermal stability, oxidation resistance, and retain their passive nature across a wide temperature range without requiring a protective atmosphere.

According to another aspect of the subject matter described herein, the method further includes adding one or more passive fillers including nanoparticles and/or microparticles to the organic solvent and dissolved dispersant, wherein the one or more passive fillers comprise SiC, Si₃N₄, Al₂O₃, ZrO₂, and/or TiO₂.

According to another aspect of the subject matter described herein, the method further includes adding one or more active fillers including nanoparticles and/or microparticles to the organic solvent and dissolved dispersant, wherein the one or more active fillers comprise ZrSi₂, TiSi₂, and/or C.

According to another aspect of the method described herein, the PDC includes organopolysilazane (OPSZ).

According to another aspect of the method described herein, the OPSZ includes Durazane 1500 or Durazane 1800.

According to another aspect of the subject matter described herein, the method further includes post-heating and/or pre-heating the metal and/or alloy at different temperatures to improve coating adhesion and anti-corrosion performance.

According to another aspect of the subject matter described herein, the method further includes applying the pre-ceramic solution on the metal and/or alloy in a humid environment to enhance the curing process.

According to another aspect of the method described herein, applying the pre-ceramic solution on the metal and/or alloy comprises using ultrasonic coating, air spraying, brushing, airless spraying, or aerosolizing to facilitate uniform distribution of the pre-ceramic solution.

According to another aspect of the method described herein, the organic solvent comprises esters, ethers, aromates, and/or ketones.

### BRIEF DESCRIPTION OF THE DRAWINGS

The subject matter described herein will now be explained with reference to the accompanying drawings of which:

FIGS. 1A-1D are images showing surface features of (A) SS316 substrate with pure D1500 coated, (B) magnified SS316 substrate with pure D1500 coated, (C) SS316 substrate with D1500 and 50 wt % ZrO₂ coated, and (D) magnified SS316 substrate with D1500 and 50 wt % ZrO₂ coated;

FIGS. 2A-2F are images showing surface features and roughness. FIG. 2A is a magnified image of a bare substrate. FIG. 2B shows surface morphology analysis of a bare substrate. FIG. 2C is a magnified image of a substrate with D1500 (D1500 (0 wt % ZrO₂ particles). FIG. 2D shows surface morphology analysis of a substrate with D1500 (D1500 (0 wt % ZrO₂ particles). FIG. 2E is a magnified image of a substrate with D1500 and 50 wt % ZrO₂ particles. FIG. 2F shows surface morphology analysis of a substrate with D1500 and 50 wt % ZrO₂ particles.

FIGS. 3A and 3B show SEM-EDS elemental mapping of ceramic coating with 50 wt % ZrO₂ particles: (A) Secondary electron image and analogous elemental mapping of the element; (B) Distribution of Zr elements (red);

FIGS. 4A and 4B are magnified cross-sections of (A) the SS316 substrate coated with D1500 and (B) the SS316 substrate coated with D1500 and 50 wt % of ZrO₂ fillers;

FIGS. 5A and 5B are magnified images showing water contact angle measurements of polysilazane coatings on SS316 substrate. (A) Durazane 1500; (B) Durazane 1500+50 wt % ZrO₂;

FIG. 6 shows roughness measurement of different areas on the surface of D1500 coating with 50 wt % ZrO₂ fillers;

FIG. 7 shows theoretical crosslinking reaction paths of Durazane 1500 under an open-air environment;

FIG. 8 is a graph of the FTIR spectra derived from D1500 and D1500 with 50 wt % ZrO₂;

FIG. 9 is a graph showing Raman spectroscopy of D1500 and D1500 with 50 wt % ZrO₂ particles from 200 to 3500 cm⁻¹;

FIG. 10 is a graph showing representative load-indentation depth (P-h) curves under 100 μN were obtained with indentation normal to the coating surface with 0 wt % ZrO₂ particles;

FIG. 11 is a graph showing representative load-indentation depth (P-h) curves under 1000 UN were obtained with indentation normal to coating surface with 50 wt % ZrO₂ particles;

FIG. 12 shows elastic properties for different indenter penetration depths (h) and filler dimensions (D), where indentations and fillers are represented by triangles and circles, separately;

FIG. 13 is a bar graph for corrosion current density of samples under 20° C., 40° C., 60° C., and 80° C.;

FIG. 14 shows SEM-EDS elemental mapping and spectra of Si, O, C, Al, and Zr throughout the RT coating;

FIGS. 15A-15J are images showing surface features and roughness. FIG. 15A is a magnified image of a bare SS304 substrate. FIG. 15B shows surface morphology analysis of a bare SS304 substrate. FIG. 15C is a magnified image of a SS304 substrate coated with D1500 and 50 wt % ZrO₂ and Al₂O₃ fillers at RT. FIG. 15D shows surface morphology analysis of a SS304 substrate coated with D1500 and 50 wt % ZrO₂ and Al₂O₃ fillers at RT. FIG. 15E is a magnified image of a SS304 substrate coated with D1500 and 50 wt % ZrO₂ and Al₂O₃ fillers at 300° C. FIG. 15F shows surface morphology analysis of a SS304 substrate coated with D1500 and 50 wt % ZrO₂ and Al₂O₃ fillers at 300° C. FIG. 15G is a magnified image of a SS304 substrate coated with D1500 and 50 wt % ZrO₂ and Al₂O₃ fillers at 500° C. FIG. 15H shows surface morphology analysis of a SS304 substrate coated with D1500 and 50 wt % ZrO₂ and Al₂O₃ fillers at 500° C. FIG. 15I is a magnified image of a SS304 substrate coated with D1500 and 50 wt % ZrO₂ and Al₂O₃ fillers at 700° C. FIG. 15J shows surface morphology analysis of a SS304 substrate coated with D1500 and 50 wt % ZrO₂ and Al₂O₃ fillers at 700° C.;

FIG. 16 is a graph showing an XRD pattern of SS304 substrate coated with D1500 with 50 wt % ZrO₂ and Al₂O₃ fillers;

FIG. 17 is a graph showing the FTIR spectra of D1500 coated SS304 substrate with 50 wt % ZrO₂ and Al₂O₃ fillers;

FIG. 18 is a graph showing the Raman spectra of D1500 coated SS304 substrate with 50 wt % ZrO₂ and Al₂O₃ fillers;

FIGS. 19A-19H show STEM images of the cross-section of coatings fabricated with 50% ZrO₂ and Al₂O₃ (A)(B) RT; (C) (D) 300° C.; (E)(F) 500° C.; and (G)(H) 700° C.;

FIGS. 20A-20E are magnified images showing water contact angle measurements of D1500/ZrO₂ and Al₂O₃ coatings on SS304 substrate (A) Bare SS304; (B) Room Temp; (C) 300° C.; (D) 500° C.; (E) 700° C.;

FIGS. 21A-21F are graphs showing the repeated potentiodynamic polarization plot of (A) Bare SS304; (B) RT; (C) 300° C.; (D) 500° C.; (E) 700° C.; aggregate of plots (A-E);

FIG. 22 is a bar graph of corrosion current density of fabricated samples;

FIG. 23 is a flow chart illustrating and example method for preparing a ceramic coating on a dry storage cannister for spent nuclear fuel; and

FIG. 24 is a diagram of an industrial component comprising a dry storage cannister for spent nuclear fuel and/or other waste where the cannister is coated with a ceramic coating formulated and applied using the methodology described herein.

### DETAILED DESCRIPTION

The subject matter described herein includes methods for preparing a protective coating or multiple layers of protective coatings on industrial components and storage systems, such as dry storage canisters for spent nuclear fuel. The protective coating(s) is prepared by dissolving a dispersant, such as DISPERBYK®-2070, in an ether, such as di-n-butyl ether. A polymer-derived ceramic (PDC) is added to the ether and dissolved dispersant to create a pre-ceramic solution, which is atomized and sprayed onto dry storage cannisters to create a coating or multiple layers of coatings for the cannisters.

The PDC can include a moisture-curable organopolysilazane (OPSZ), such as Durazane® 1500 (D1500). D1500 can cure at room temperature so does not require annealing at high temperatures, which can be restrictive and costly. The PDC can alternatively include other PDCs that require high temperatures to cure, such as Durazane® 1800, in which instance the coated canister can be cured at about 150° C. and then at about 800° C. The pre-ceramic solution can also include one or more metal oxides including, without limitation, zirconium oxide, aluminum oxide, titanium oxide, and/or iron oxide.

### High-Level Summary of Evaluation of Coatings for DSCs

Dry storage casks/canisters play a significant role in storing high-level waste from spent nuclear fuel due to the present absence of a permanent geological repository. Since dry storage casks/canisters are often placed in coastal or lakeside regions, it is easy to suffer chloride-induced stress corrosion cracking due to the aggressive environment. This study evaluates the mechanical properties and anti-corrosion performance of D1500 coating with 50 wt % ZrO₂ fillers on the stainless steel (SS316) substrates, in which the coating(s) were deposited by airbrush and cured in the ambient environment at room temperature to obtain a physical barrier for corrosion inhibition. We evaluated the evolution of pre-ceramic solution into ceramics through Fourier-transform infrared spectroscopy (FTIR). The result indicated that the D1500 film and D1500 film with 50 wt % ZrO₂ fillers were almost completely cured after 90 days. Besides, the D1500 coating showed good hydrophobicity, while Young's modulus and hardness for the D1500 coating are 5.53 GPa and 0.85 GPa, respectively. The electrochemical results showed both SS316 substrates coated with D1500 had one order of magnitude lower than bare SS316 in corrosion current density, leading to superior corrosion resistance with temperature increased from 20° C. to 80° C. This work confirms the potential of depositing ceramic coating(s) on metal or alloy substrates to inhibit corrosion and an efficient deposition by airbrush.

In this study, we deposited a commercially available OPSZ-derived film on SS316 substrates through an airbrush under the ambient environment. A series of characterization techniques were conducted to study the corrosion resistance and mechanical properties of deposited ceramic films. Coating thickness and surface characterization were obtained through a scanning electron microscope (SEM) and laser confocal microscope. The crosslinking degree of the coatings was monitored by FTIR and Raman spectroscopy. The corrosion resistance was investigated through electrochemical experiments from 20° C. to 80° C., while nanoindentation was performed to get hardness and Young's modulus of coatings.

### 1. Motivation

One method for protecting stainless steel is to deposit a physical barrier to protect stainless steel from the corrosive environment. In 2020, Yeom et al. deposited a stainless steel coating by cold spray technology to mitigate CISCO, in which this coating sealed the crack openings and served as a physical barrier. Fusco et al. studied the coating effects of TiN, ZrO₂, TiO₂, Al₂O₃, and MoS₂ on stainless steels through magnetron sputtering, showing promise in reducing corrosion. However, these deposition methods require either high energy consumption or high-cost equipment, not to mention the difficulty of large-area deposition.

Fortunately, the application of polymer-derived ceramics technology (PDC) enables the deposition of the ceramic coating through convenient solution-processed methods, such as dip coating, spin coating, and spray coating. When exposed to thermal, chemical, or irradiation treatment, these pre-ceramic polymers can be converted into ceramics. Since this conversion happens after coating deposition, people can adopt plastic-forming techniques to generate shaped components with low cost and simple operation. In addition, passive (such as SiC, Si₃N₄, Al₂O₃, ZrO₂, and TiO₂), active fillers (e.g., ZrSi₂, TiSi₂, and C), glass or sacrificial fillers (mostly organic compounds) have been employed in the coating solution to tailor the functionality of the final ceramic. Thus far, many studies have investigated the performance of pre-ceramic polymers as an environmental barrier coating to protect structural material from the harsh environment. Recently, moisture-curable organopolysilazane (OPSZ), one of the famous PDC materials, was proposed to achieve a highly cross-linked ceramic coating through thermal (<240° C.) or chemical curing. Unlike other OPSZs that need high-temperature pyrolysis (up to 800° C.), this type of OPSZ can react with the moisture in the air and then form a ceramic layer with the release of hydrogen and ammonia as by-products. Rossi et al. conducted a series of tests to investigate the corrosion protection of OPSZ-derived coatings on steels. The tests revealed that the OPSZ coating with several microns could offer enhanced corrosion protection compared to bare substrates. Zhan et al. also evaluated the mechanical properties and hydrophobicity of moisture-curable OPSZ coatings at room temperature.

Room-temperature fabrication is always preferred in industrial applications, reducing energy consumption and simplifying the production process. Nevertheless, no systematic research has been conducted for moisture-curable OPSZs with microparticles in the field of corrosion protection towards stainless steel. Hence, we feel obligated to introduce this moisture-curable polymer to protect steel canisters from corrosion without high temperature and inert gas involved. For solution-processed deposition methods, spray coating, a high-throughput large-area deposition technique, is well established to deposit coatings at an industrial scale and in research advancement. By atomizing the solution and depositing it onto the substrate, this flexible spraying method ensures a minimum requirement for the substrate shape. In addition, the adjustment of parameters, e.g., the pressure of the carrier gas, the diameter of the spray nozzle, the distance between the nozzle and substrate, etc., offers the opportunity to control the viscosity, filler sizes, coating thickness, and other preferred characteristics. Therefore, spray coating has been intensively applied in industrial coatings, polymer solar cells, and painting. Considering the requirements of large-area deposition or re-deposition, spray coating is a promising method for applying ceramic coating on the stainless steel substrates. Until now, not much work has been done on polymer-derived coatings via spray deposition.

In this study, we deposited a commercially available OPSZ-derived coating on SS316 substrates through an airbrush under the ambient environment. A series of characterization techniques were conducted to study the corrosion resistance and mechanical properties of deposited ceramic coatings. Coating thickness and surface characterization were obtained through a scanning electron microscope (SEM) and laser confocal microscope. The crosslinking degree of the coatings was monitored by FTIR and Raman spectroscopy. The corrosion resistance was investigated through electrochemical experiments from 20° C. to 80° C., while nanoindentation was performed to get hardness and Young's modulus of coatings.

### 2. Materials and Fabrication Methods

Coatings with 50 wt % ZrO₂ based on OPSZ were prepared with 0.5 ml commercially available Durazane 1500 (Merck KGaA, Germany). In the first stage, the dispersant DISPERBYK-2070 (BYK, USA) was dissolved in 2 ml di-n-butyl ether (purity>99%, Alfa Aesar). Then, zirconium oxide (99.9% metal base, the average size of ZrO₂ particle is 0.3-0.7 μm) purchased from Inframat Advanced Material Company (Manchester, USA) was added and dispersed with 40 min ultrasound. The Durazane 1500 was added to the suspension and mixed well. In the last step, the airbrush atomized the mixed solution and deposited it on the SS316 substrates. Then, samples with coatings were dried in the air at room temperature. SS316 is one of the most common stainless steel for fabricating dry storage casks. The sample size is 1-inch diameter and 1/10-inch thickness with 2B finish grade, in which their surface achieves a smooth and reflective sheen.

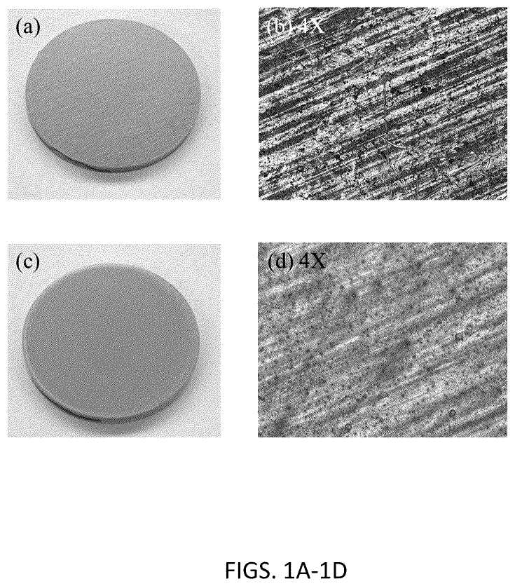

FIGS. 1A-1D presents the surface features of SS316 substrates coated with D1500 (FIGS. 1A and 1B) and D1500 (FIG. 1C and FIG. 1D with 50 wt % of ZrO₂ particles. As shown in FIG. 1B, there are clear rolled trails in the transparent coating, while the coating with the addition of 50 wt % ZrO₂ shows a white-transparent color and covers part of the trails. As shown in FIG. 1C, the edge area of coating with ZrO₂ particles is not uniform, where many particles seem to be pulled to the edge by the air pressure. This phenomenon can be attributed to the fact that many factors are involved in the spraying operation. Reproducibility and homogeneity strongly depend on the operator's performance. Nevertheless, operations systems with an advanced mechanic or electronic control could play an important role in improving the reproducibility of the process and the homogeneity of the coatings. In summary, FIGS. 1A-1B manifest an apparent difference between the pure D1500 coating and D1500 coating with 50 wt % ZrO₂ particles under a 4× magnification. The color of ceramic coating with 50 wt % ZrO₂ particles is much whiter than the pure D1500 coating, indicating an effective and strong coating.

### 3. Material Characterization

### 3.1 Surface Analysis

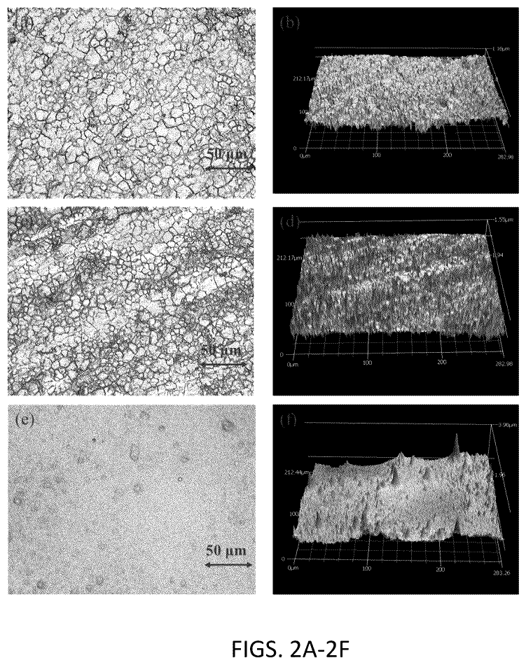

In this study, the surface roughness of substrates was evaluated using a laser confocal microscope from Keyence (VKX1000). Additionally, the particle distribution and coating thickness were determined through SEM/FIB/EDS analysis conducted on a ThermoFisher Quanta 3D FEG instrument. The results of the surface morphology analysis are presented in FIGS. 2A-2F, which displays the surface characteristics of the bare SS316 substrate, as well as the substrates coated with D1500 and 50 wt % ZrO₂ fillers.

Multiple samples were analyzed in various regions, and the average surface roughness values were calculated and summarized in Table 1. The results show that the average surface roughness of the bare substrate was 0.24 μm, while the substrate coated with diluted D1500 had a surface roughness of 0.24 μm. The substrate coated with diluted D1500 and ZrO₂ fillers had a slightly higher average surface roughness of 0.43 μm, which was expected due to the presence of ZrO₂ particles (0.3-0.7 μm) in the coating.

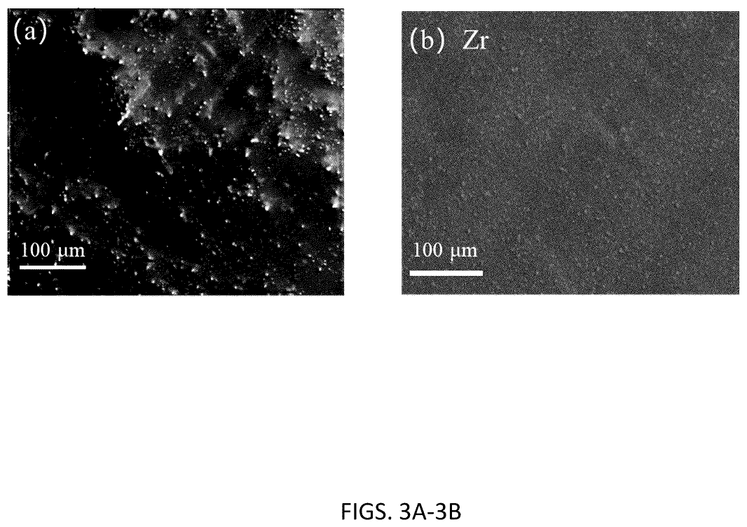

FIGS. 3A and 3B present the distribution of ZrO₂ particles and the elemental mapping of Zr elements. The results show that the ZrO₂ fillers were evenly dispersed on the surface of the D1500 coating with 50 wt % ZrO₂, and no cracks were observed. These results demonstrate the successful incorporation of ZrO₂ fillers into the D1500 coating and the formation of a homogeneous surface with improved surface roughness.

TABLE 1
Surface roughness of different samples.

| Sample | Roughness (μm) | Error (μm) |
|---|---|---|
| Bare substrate | 0.24 | 0.03 |
| Coating with 0 wt % ZrO₂ | 0.24 | 0.04 |
| Coating with 50 wt % ZrO₂ | 0.43 | 0.11 |

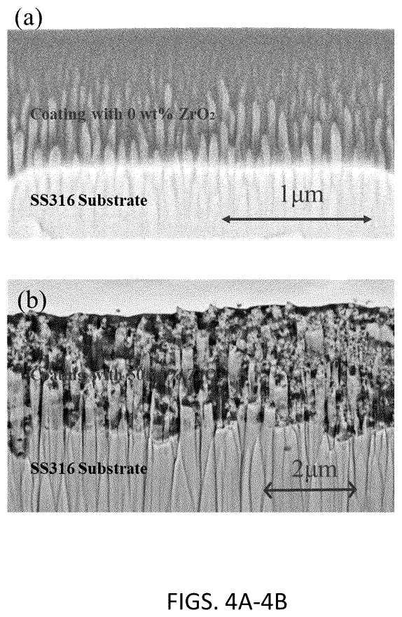

The SEM cross-sectional image of coatings with 0 wt % and 50 wt % ZrO₂ particles was obtained through the metal-ceramic interface to investigate the adhesion condition and thickness between the D1500 coating and SS316 substrates. As shown in FIGS. 4A and 4B, the coating was deposited well on the SS316 substrate without any cracks and porous structure. The thickness of coating with 0 wt % and 50 wt % ZrO₂ particles are around 3 μm and 1 μm, in which the difference should be contributed to the addition of 50 wt % ZrO₂ particles (0.3-0.7 μm), and thereby the increase in slurry viscosity.

### 3.2 Contact Angle Measurement

Hydrophobic property is an encouraging factor for decreasing the corrosion rate of metals or alloys, limiting their interactions with corrosive species, such as water and ions. A goniometer from FDS Corp Dataphysics OCA with a digital camera and an automatic drop dispenser was employed to determine the contact angle (θ) of 5 μL water on the coated SS316 substrate.

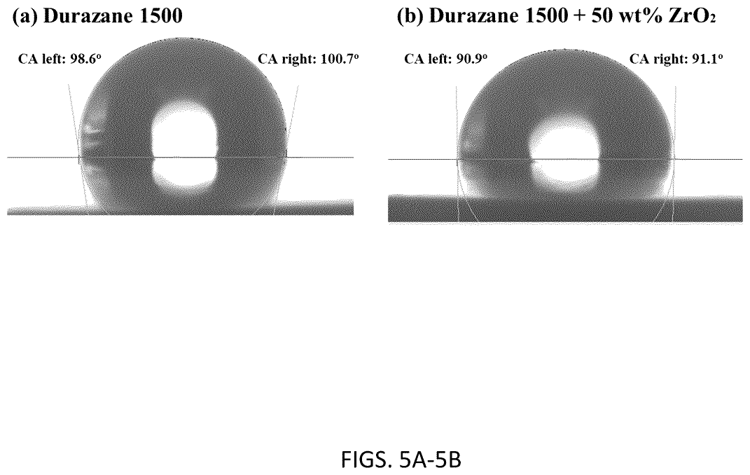

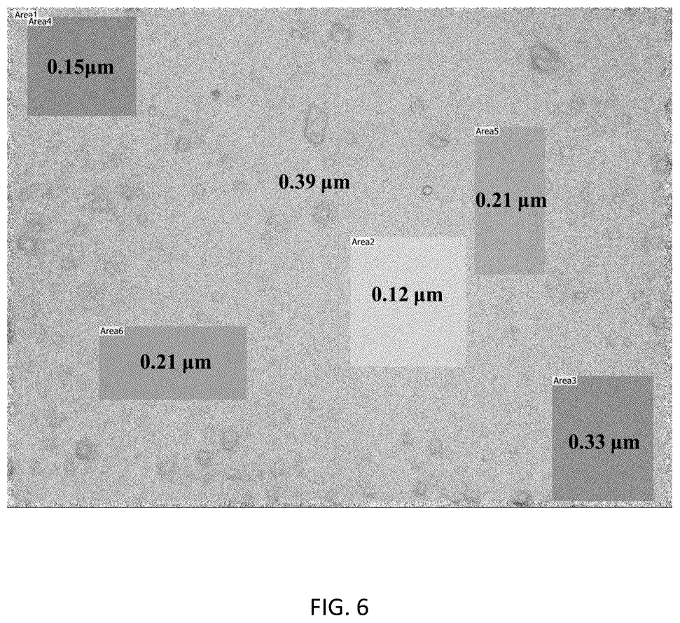

Here we conducted repeated contact angle measurements to study the hydrophobic property of coated SS316 substrate. As sampled in several different areas, Table 2 includes the average value of contact angles. The representative measurements are illustrated in FIGS. 5A and 5B. The results show that the SS316 substrate coated with D1500 has an average contact angle of 99.5°, while the contact angle of D1500 with 50 wt % ZrO₂ particles is only 89.9°. It indicates that both of the two coatings have superior hydrophobic properties to bare SS316 substrate.

TABLE 2
Contact angles of coated substrates.

| Surface | Contact angle |
|---|---|
| Durazane 1500 | 99.5° ± 0.61° |
| Durazane 1500 + 50 wt % ZrO₂ | 89.9° ± 1.32° |

The relationship between surface roughness and hydrophobicity has been well established in the literature, where it has been proposed that an increase in surface roughness would result in an improvement of hydrophobic properties. This is because the trapped gas layer between an aqueous solution and a rough hydrophobic substrate increases with the hydrophobicity and the roughness of the substrate. However, in our study, we observed a discrepancy from this established phenomenon, as the hydrophobicity of the D1500 coating with 50 wt % ZrO₂ fillers showed a decrease, despite the increased roughness.

In order to understand this unexpected result, we conducted a detailed analysis of the regional roughness of the coating with fillers. FIG. 6 illustrates the measurement results, which showed that the overall roughness of D1500 with 50 wt % ZrO₂ filler was elevated due to the deposition spots on the surface resulting from high ZrO₂ filler loading. Conversely, the regional roughness in other areas was reduced to less than 0.2 μm.

The data obtained from this regional analysis provides clear evidence that while the overall roughness was higher, the regional roughness was lower than both the bare substrate and the D1500 coating. This reduction in regional roughness could have resulted in reduced air entrapment, and thus may explain the decrease in hydrophobic ability observed in the D1500 coating with 50 wt % ZrO₂ fillers. In conclusion, while the relationship between surface roughness and hydrophobicity has been established in the literature, the present study highlights the importance of considering regional roughness in the evaluation of hydrophobic properties.

### 3.3 Spectroscopy Analysis

The Fourier transform infrared spectroscopy (FTIR) measurement was conducted to determine the functional groups and bonding types in D1500/ZrO₂ composites. By using a Thermo Fisher FTIR models-iS10 equipped with an OMNI attenuated total reflectance probe (ATR) and Germanium (Ge) crystal, the absorbance spectrums were obtained in the 450-4000 cm⁻¹ spectral region.

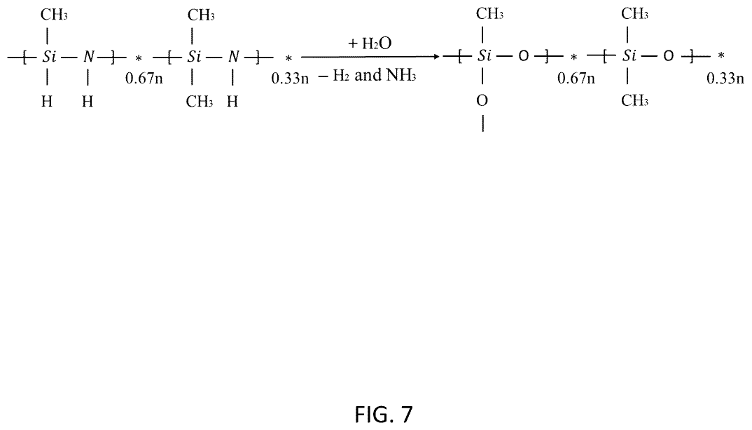

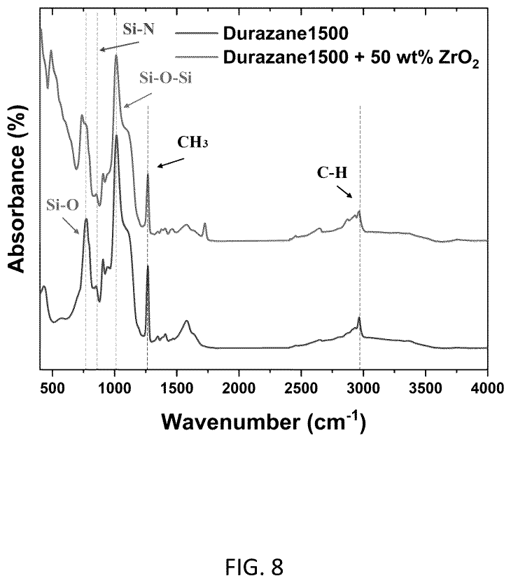

FIG. 7 shows the theoretical crosslinking reaction paths of D1500 under ambient environment and room temperature, where D1500 reacts with the moisture from the air and then releases NH₃ and H₂ based on hydrolysis and condensation reactions. The FTIR spectra shown in FIG. 8 correlate well with the theoretical reaction path. After more than 90 days of curing in the ambient environment, the hydrolysis reaction results in nearly total consumption of the N—H groups since no N—H was found in the FTIR spectra. This phenomenon is consistent well with the investigation by Zhan et al. The strongest peaks come from the vibration at 1022⁻¹ (O—Si—O), 1274 cm⁻¹ (Si—CH₃), about 1403 cm⁻¹ (CH₃), and 800 cm⁻¹ (Si—C). Furthermore, two spectrums both exhibit a weak peak of the N—Si—N network at 910 cm⁻¹ (Si—N), which could result from an incomplete curing.

Above all, these findings can be summarized as follows: (i) after 90 days, the film achieved almost complete curing of the film with the hydrolysis of all the NH; (ii) the hydrolysis of the Si—H bonds seems finished with only the Si—O bond has been found; and (iii) the presence of part of non-converted Si—N—Si and Si—O—Si bonds suggests the formation of two-phase material to some degree.

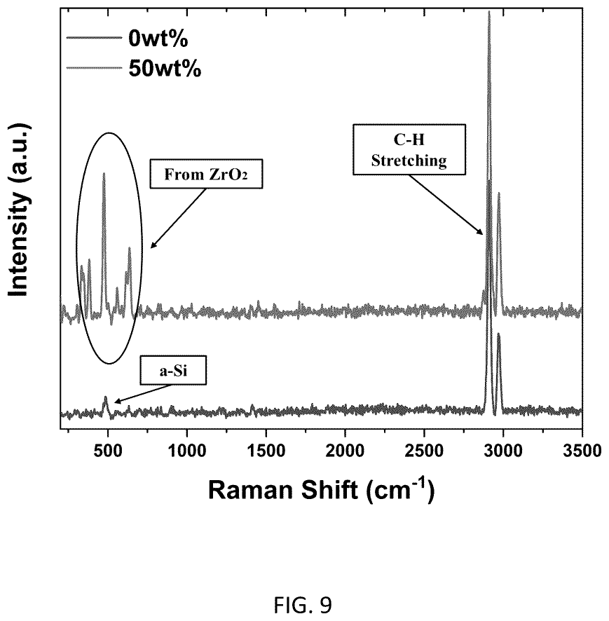

To determine the functional groups in D1500/ZrO₂ composites, a confocal Raman microscope (SENTERRA II) from Bruker was employed to scan the Raman-shift range from 55 cm⁻¹ to 4284 cm⁻¹. FIG. 9 shows the typical Raman spectroscopy of D1500/ZrO₂ composites from 200 to 3500 cm⁻¹. As expected, the difference between pure D1500 and D1500/ZrO₂ comes to ZrO₂ fillers, lying at 330 cm⁻¹, 381 cm⁻¹, 466 cm⁻¹, 548 cm⁻¹, and 641 cm⁻¹ from monoclinic ZrO₂. The overlapping peaks around 484 cm⁻¹ and 3000 cm 1 belong to the amorphous silicon and CH₃ stretching peak. Detailed band assignments are listed in Table 3.

TABLE 3
Band assignments of Raman spectra
of D1500 and ZrO₂ composites.

| Materials | Wavelength (cm⁻¹) |
|---|---|
| ZrO₂ | 330 (B_{g}) |
| | 381 (A_{g}) |
| | 466 (A_{g}) |
| | 548 (A_{g}) |
| | 631 (A_{g}) |
| D1500 | 484 (a-Si) |
| | 2910 and 2973 (CH₃ stretching) |

### 3.4 Nanoindentation

High values of mechanical properties, such as Young's modulus and hardness, are an important factor for the fabrication and stable in-service protection of coatings on the surface of DCSs. Nanoindentation measurements were carried out to study the mechanical properties of D1500 coatings through Bruker Hysitron TI980 Triboindenter. The displacement resolution and load resolution are 0.006 nm and 1 nN, separately.

After calibrated with fused quartz, several nanoindentation measurements were conducted with a Berkovich tip when the indenter axis was aligned perpendicular to the surface of super-glued substrates. Since the indentation depth should be controlled at less than 10% of the coating thickness to avoid the substrate effect, we selected the load force at 100 μN for pure D1500 coating, while 1000 UN for D1500 with 50 wt % ZrO₂ particles.

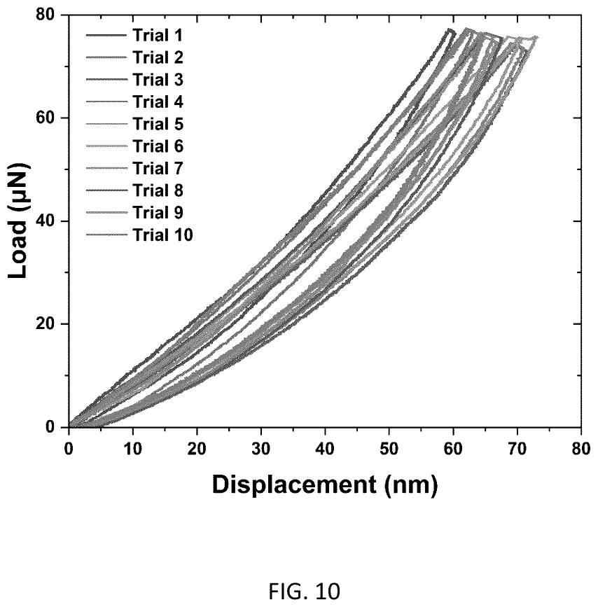

With the peak load force at 100 μN, the loading/unloading time and the holding time at peak loads were maintained at 20 s and 10 s, respectively. FIG. 10 shows the typical load control displacement curves under 100 UN for the pure D1500 coating. To summarize the nanoindentation results, Table 4 provides the experimental values of Young's modulus (E) and hardness (H) based on 10 indenting points from five different sampling areas. The overall results manifest that, at room temperature, Young's modulus and hardness of the coating with 0 wt % ZrO₂ particles are around 5.53 GPa and 0.85 GPa, separately. The experimental results are higher than the reported values of other groups, where E and H of D1500 are around 2.9 GPa and 0.29 GPa after curing for 30 days, respectively. However, they found that the hardness and Young's modulus of D1500 coatings still grew further slowly even after 30 days of curing. The available evidence seems to suggest that a physical crosslinking process through hydrophobic interaction and chain entanglement possibly occurs apart from chemical crosslinking reactions. Since these D1500 coatings were cured around five months, it is reasonable to have a higher E and H in our case.

TABLE 4
Young's modulus (E) and hardness (H) of coating
with 0 wt % ZrO₂ particles under 100 μN.

| E | Standard Dev. | H | Standard Dev. |
|---|---|---|---|
| (GPa) | (GPa) | (GPa) | (GPa) |
| 5.53 | 0.63 | 0.85 | 0.12 |

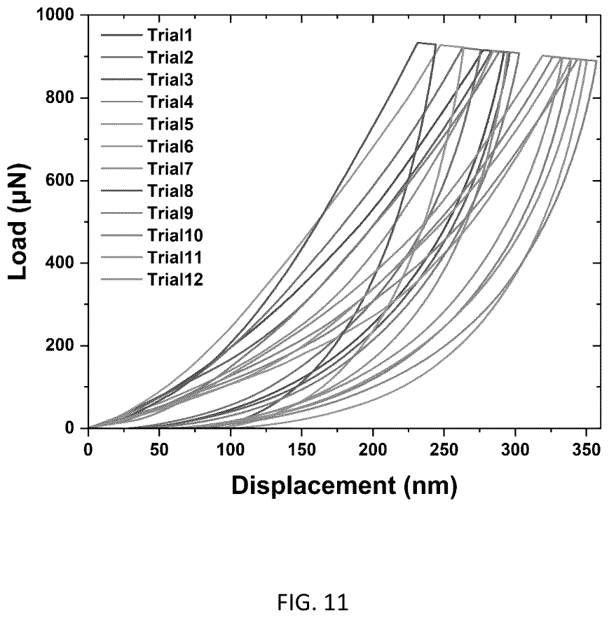

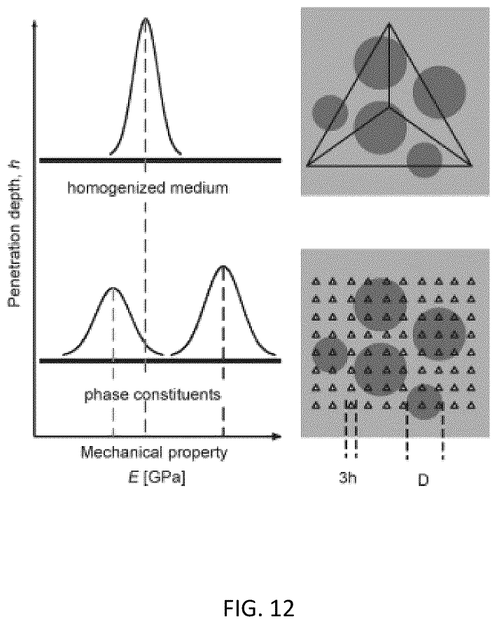

As for D1500 coating with 50 wt % ZrO₂ particles, the data gathered in the nanoindentation measurements suggest that its E and H have a larger distribution (FIG. 11) than the coating with 0 wt % ZrO₂ particles in Table 5. There is overwhelming evidence for the abnormal deviations that particles size within the composites strongly affects local mechanical performance. As shown in FIG. 12, the E and H in the composites depend on the filler size (D) and displacement depth (h). When h>>D, there should be a single value of E and H reflecting the mechanical properties of the homogeneous composite. When h<<D, each E and H only indicates the mechanical property of a small grid area.

TABLE 5
Young's modulus (E) and hardness (H) of the D1500
coating with 50 wt % ZrO₂ particles under 1000 μN.

| E (GPa) | H (GPa) |
|---|---|
| 7.45 | 0.67 |
| 7.28 | 0.79 |
| 7.18 | 0.65 |
| 6.52 | 0.47 |
| 6.50 | 0.37 |
| 11.71 | 0.65 |
| 8.88 | 0.53 |
| 12.36 | 0.78 |
| 6.67 | 0.57 |
| 5.71 | 0.37 |
| 5.41 | 0.42 |
| 6.05 | 0.45 |

### 3.5 Electrochemical Experiments

The electrochemical experiments were performed to investigate the anti-corrosion property of the deposited D1500 coatings. The setup is based on the MULTIPORT™ corrosion cell kit and Interface 1000 potentiostat from Gamry Instruments with the DC105 Electrochem software. The exposed area of our samples to MgCl₂ solution is 3.14 cm2. 0.54 mol/L of MgCl₂ solution was prepared based on Magnesium chloride hexahydrate (MgCl₂-6H₂O) from Thermal Scientific and deionized water. MgCl₂ was selected as the corrosive solution since it is one of the most detrimental in austenitic stainless steel.

Prior to the experiments, we purged the solution with nitrogen for 3 hours to remove the oxygen and then immersed the specimen into the MgCl₂ solution for 24 hours to obtain a stable open circuit potential based on the ASTM G61 standard. Finally, our experiment starts the potential scan at the corrosion potential with a scan rate of 0.6 mV/s. Temperature plays a significant role in the electrochemical corrosion of metals. For example, it can change the diffusion rate, the overvoltage of electrode processes, and the material solubility. As a result, we studied the corrosion behavior of bare SS316, SS316 coated with D1500, and SS316 coated with D1500 and 50 wt % ZrO₂ at an increasing temperature from 20° C. to 80° C. The corrosion cell was immersed in a temperature-controlled water bath.

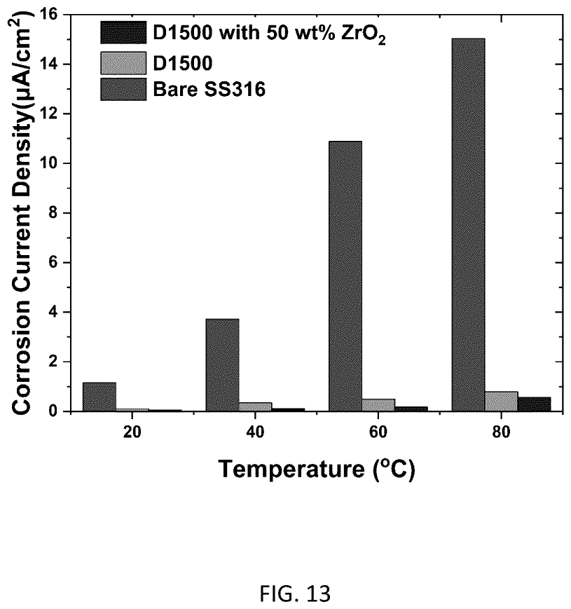

FIG. 13 shows the corrosion current density of three samples. As expected, the current density increases with the increasing temperature among these samples. Several studies have reported an elevated corrosion rate when increasing the temperature within a specific range. Konovalova et al. proposed that the accelerated corrosion was attributed to increasing active corrosion centers on the metal surface because of the elevated temperature. In addition, the current density of coated substrates is much lower than the bare SS316. The dramatic drop in the corrosion current density of the coated SS316 substrate could be caused by the dielectric nature of the D1500 and ZrO₂ fillers. This detected electrochemical activity might be related to the localized activity, where coatings are not intact due to the presence of cracks, micropores, or uncovered deposition. This result manifests the corrosion inhibition of D1500 coatings on SS316 substrates as a physical barrier. Furthermore, the corrosion resistance of D1500 with 50 wt % ZrO₂ fillers is better than D1500 due to the presence of a thicker coating. The values of current corrosion density for samples under 20° C., 40° C., 6° C., and 80° C. are presented in Table 6.

TABLE 6
Corrosion current density and corrosion rate
for bare and coated samples under 20°
C., 40° C., 60° C., and 80° C.

| | Temperature | Corrosion current density |
|---|---|---|
| Sample | (° C.) | (μA/cm²) |
| Bare SS316 | 20 | 1.15 |
| | 40 | 3.72 |
| | 60 | 10.89 |
| | 80 | 15.03 |
| SS316 coated | 20 | 0.10 |
| with D1500 | 40 | 0.34 |
| | 60 | 0.50 |
| | 80 | 0.79 |
| SS316 coated | 20 | 0.05 |
| with D1500 and | 40 | 0.11 |
| 50 wt % ZrO₂ | 60 | 0.17 |
| | 80 | 0.56 |

### 4 Conclusion

In this study, we proposed an efficient airbrush to deposit pre-ceramic polymers on the surface of stainless steel to protect it from corrosion. A series of experimental results were presented to confirm the efficiency of airbrush and moisture-curable ceramics, indicating great corrosion resistance to MgCl₂ solution and excellent mechanical properties.

We evaluated the evolution of pre-ceramic solution into ceramics through FTIR. The result indicated that the D1500 film and D1500 film with 50 wt % ZrO₂ fillers achieved almost complete curing with the hydrolysis of all the NH after 90 days. Besides, the pure D1500 coating had a better hydrophobicity than the D1500 coating with ZrO₂ fillers due to the uneven roughness distribution. The Young's modulus and hardness for the pure D1500 coating were 5.53 GPa and 0.85 GPa, separately. The electrochemical corrosion experiments were performed to investigate the anti-corrosion property of the deposited D1500 coating in 0.54 mol/L MgCl₂ solution at 20° C., 40° C., 60° C., and 80° C. It indicated that both SS316 substrates with coated D1500 showed a lower corrosion current density than bare SS316, resulting in superior resistance to corrosion with temperature increased from 20° C. to 80° C. This study validates the excellent anti-corrosion property of D1500 coatings and the efficiency of airbrush deposition. It should shed some light on protecting steel canisters from corrosion by depositing moisture-curable ceramic layers.

### Performance of Ceramic Coating on Dry Storage Canisters Through Spray Coating

This section describes a study that evaluates the structural evolution and anti-corrosion performance of organopolysilazane coating (Durazane 1500) with 50 wt % micro fillers on SS304 substrates, in which the coating was deposited by spray coating and annealed at varied temperatures. Fourier-transform infrared (FTIR) and Raman spectroscopy were employed to evaluate the evolution of pre-ceramic solution into ceramics. Our findings demonstrate that annealing promotes almost complete hydrolysis of Durazane 1500, but can lead to coating decomposition at temperatures exceeding 700° C. In addition, our observations revealed that the coatings exhibited favorable hydrophobic properties, as evidenced by a contact angle exceeding 90°, except for the sample annealed at 700° C. To further assess the efficacy of Durazane 1500 coating, we conducted electrochemical corrosion experiments in 0.54 mol/L MgCl₂. Samples annealed at room temperature, 300° C., and 500° C. exhibited lower corrosion current than bare SS304, indicating superior corrosion resistance. Conversely, samples annealed at 700° C. exhibited the poorest corrosion inhibition due to the coating's degradation at high temperatures. This work confirms the outstanding corrosion inhibition of Durazane 1500 coatings and demonstrates the efficacy of annealing. Future research will focus on optimizing annealing conditions and formulations to enhance coating performance for steel canister corrosion protection.

### 1. Introduction

In this study, we applied commercially available OPSZ-derived coatings onto SS304 substrates under ambient atmospheric conditions. To examine the impact of annealing, the coatings were incorporated with 50 wt % ZrO₂ and Al₂O₃ particles and subjected to annealing at temperatures of 300° C., 500° C., and 700° C. for 40 minutes in a nitrogen atmosphere. A comprehensive set of surface characterization, phase analysis, and electrochemical experiments were performed to investigate the influence of annealing on the properties of these coatings.

### 2. Materials and Preparation

Commercially available OPSZ (Durazane 1500), provided by Merck KGAA, Germany, were used in their as-received state without the need for additional purification. A series of coatings with 50 wt % ZrO₂ and Al₂O₃ were prepared with 0.5 ml Durazane 1500 (D1500). Initially, the dispersant DISPERBYK-2070 (BYK, USA) was dissolved in 2 ml di-n-butyl ether (purity>99%, Alfa Aesar, followed by the addition of zirconium oxide (ZrO₂, Inframat Advanced Material, USA) and aluminum oxide particles (Al₂O₃, Allied, CA). dispersed with 40 min magnetic stirring. The average size of ZrO₂ and Al₂O₃ particles is 0.3-0.7 μm and 0.3 μm, separately. The mixture was then dispersed for 40 minutes with magnetic stirring, Next, Durazane 1500 was added to the suspension and thoroughly mixed. The mixed solution was then atomized by an airbrush and deposited onto SS304 substrates, which were subsequently dried at room temperature. After 24 hours, the samples were annealed with nitrogen flow for 40 minutes at 300° C., 500° C., and 700° C. Table 7 presents the element composition of 304 stainless steel, while Table 8 shows the sample code for the comparative study.

TABLE 7
Typical element composition of 304 stainless steel.

| Elements | Mn | Si | Cr | Mo | Ni | Co | Fe |
|---|---|---|---|---|---|---|---|
| Weight % | 0-2 | 0-1 | 17.5-24 | 0-2.5 | 8-15 | 0-0.29 | Balance |

TABLE 8
Sample codes under different annealing conditions.

| Sample | Contact Angle (°) | Error (°) |
|---|---|---|
| Bare SS304 | — | — |
| RT | 102.90 | 1.28 |
| 300° C. | 96.10 | 1.09 |
| 500° C. | 111.09 | 0.61 |
| 700° C. | 26.04 | 3.17 |

### 3. Result and Analysis

### 3.1 Surface Analysis

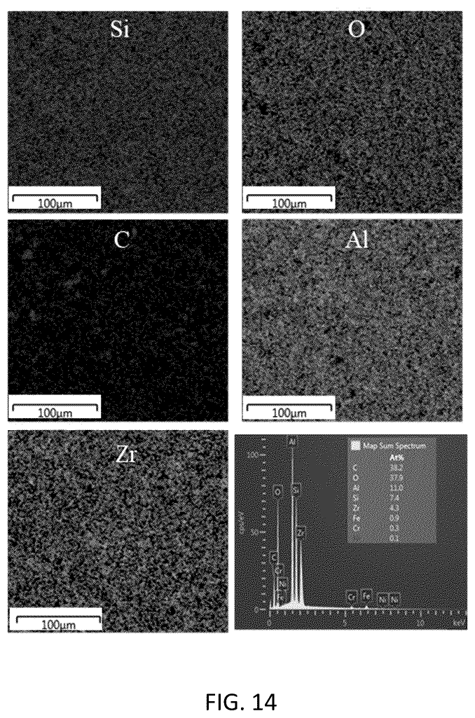

FIG. 14 presents the surface elemental analysis of the room temperature (RT) sample using a combination of scanning electron microscopy (SEM) and energy dispersive X-ray spectroscopy (SEM-EDS) with the ThermoFisher Quanta 3D FEG system. The acquired spectra indicate the presence of silicon (Si), oxygen (O), carbon (C), aluminum (AI), and zirconium (Zr) elements on the surface of the RT coating. Notably, the surface exhibits uniform dispersion of ZrO₂ and Al₂O₃ throughout the coating.

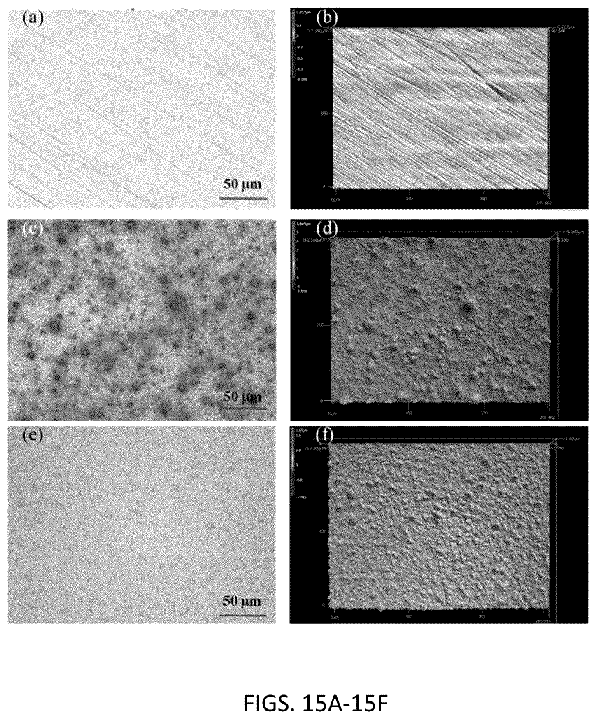

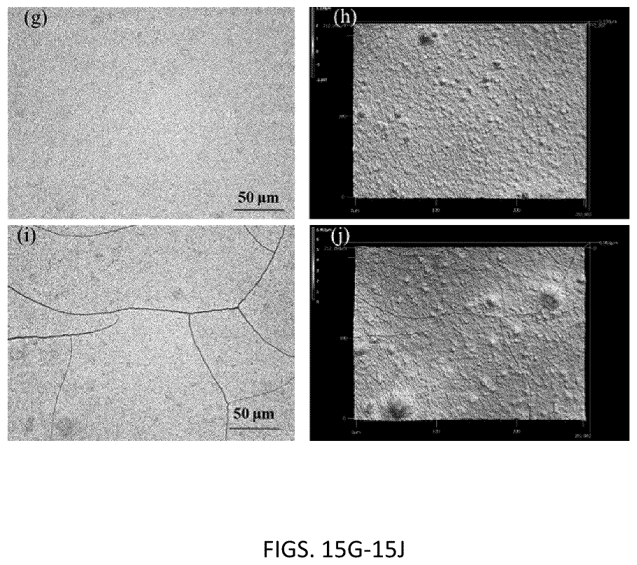

The surface roughness of the bare SS304 substrate and the substrate coated with D1500 and 50 wt % ZrO₂ and Al₂O₃ fillers was studied using a laser confocal microscope (Keyence VKX1000), as shown in FIGS. 15A-15J, which illustrate the surface morphology. As sampled in multiple areas and samples, Table 9 concludes the average surface roughness of samples. As expected, particles scattered evenly within the D1500 coating, while some particle aggregations were still observed due to insufficient mixing and stirring. The roughness of Bare SS304 and RT are 0.240 μm and 0.644 μm, separately. As expected, the existence of ZrO₂ particles (0.3-0.7 μm) and Al₂O₃ (0.3 μm) contributes to this huge difference in roughness. Simultaneously, the roughness of 300° C., 500° C., and 700° C. are all smaller than RT. It could be ascribed to the fact that annealing helps to complete the coating curing and particle diffusion, and then reduce the roughness accordingly. Furthermore, surface cracks were observed in 700° C. sample, and it may be the reason for a higher value of roughness. As processed at high temperatures up to 700° C., very large thermal stress is induced due to the different thermal expansion coefficients between coatings and substrates.

TABLE 9
Surface roughness of different samples.

| Sample | Roughness (μm) | Error (μm) |
|---|---|---|
| BareSS304 | 0.240 | 0.114 |
| RT | 0.644 | 0.136 |
| 300° C. | 0.274 | 0.065 |
| 500° C. | 0.332 | 0.084 |
| 700° C. | 0.437 | 0.078 |

### 3.2 Structure Analysis

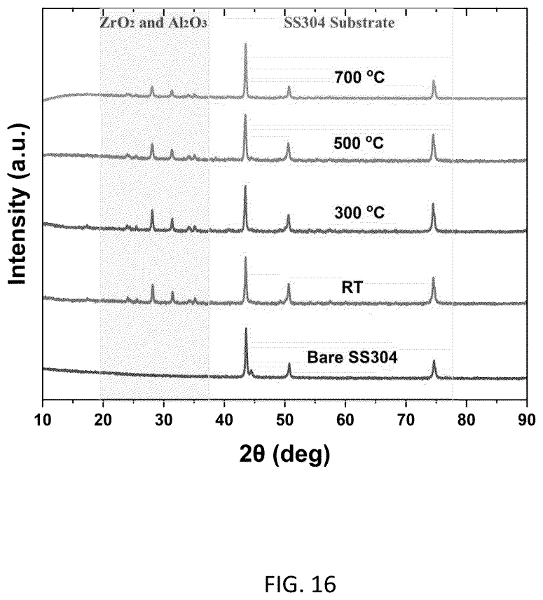

X-ray diffraction (XRD) analysis was conducted using the Rigaku SmartLab X-Ray diffractometer to investigate the structural characteristics of the produced samples. The XRD patterns were obtained under specific conditions, utilizing a linear accelerator detector with a copper anticathode. The experimental parameters included a 20 range of 10°-90° and a step size of 0.026. FIG. 16 illustrates the XRD results, displaying distinct diffraction patterns corresponding to ZrO₂ and Al₂O₃ particles. The observed full width at half-maximum (FWHM) value of 0.25° confirms the presence of highly crystalline ZrO₂ particles embedded within the D1500 coating. Moreover, due to the larger particle size of ZrO₂ fillers (0.3-0.7 μm) compared to Al₂O₃ fillers (0.3 μm), the peak intensity for ZrO₂ is significantly higher, while only a minor peak at 25.6° corresponds to Al₂O₃ particles. Moreover, strong peaks detected in all coated samples suggest the potential presence of elements such as Cr, Mn, or other constituents originating from the SS304 substrate. Notably, the XRD analysis indicated no observed phase changes in the particles, even with higher annealing temperatures of up to 700° C.

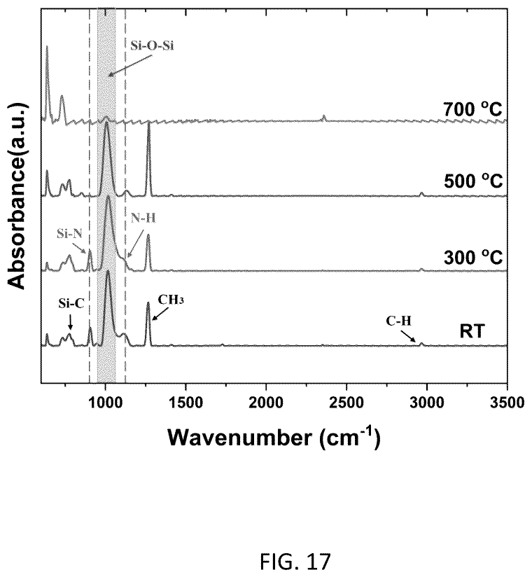

The FTIR measurement was conducted to determine the functional groups and bonding types in D1500/ZrO₂ and Al₂O₃ composites. By using the LUMOS II equipped with an attenuated total reflectance probe (ATR) from Bruker, the absorbance spectrums were obtained in the 400-3500 cm⁻¹ spectral region. FIG. 17 illustrates the theoretical crosslinking reaction paths of D1500 under ambient conditions and room temperature, involving the reaction of D1500 with moisture from the air and subsequent release of ammonia (NH₃) and hydrogen (H₂) based on hydrolysis and condensation reactions. The normalized FTIR spectra shown in FIG. 17 correlate well with the theoretical reaction path. The peak intensity of N—H and Si—N groups decreases with higher annealing temperatures, while the peak intensity at 1022 cm⁻¹ (O—Si—O) increases with the annealing temperature, indicating that annealing may help to facilitate the hydrolysis reaction. Furthermore, RT and 300° C. both exhibit a weak peak of the N—Si—N network at 910 cm⁻¹ (Si—N), which could result from incomplete curing of D1500. Surprisingly, no functional group from the Si—N—Si or Si—O—Si system was detected at 700° C., providing compelling evidence for the structural decomposition of the coating at higher annealing temperatures.

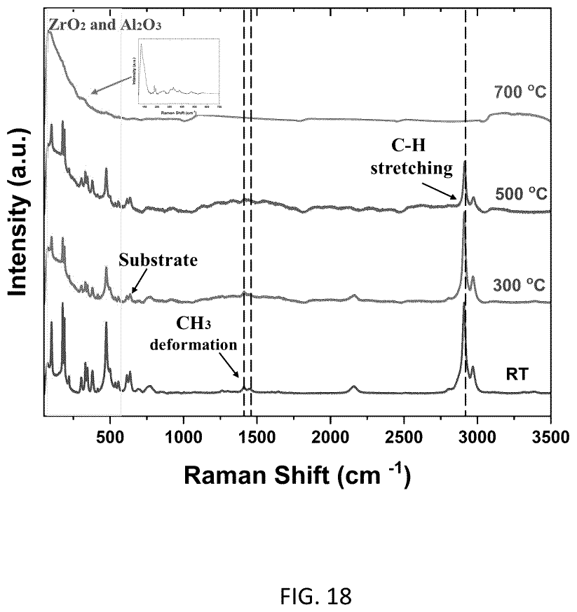

To determine the functional groups in D1500/ZrO₂ and Al₂O₃ composites, Confocal Raman Microscope (Horiba XploRA PLUS) was employed with scanning the Raman-shift range from 50 cm⁻¹ to 3500 cm⁻¹ FIG. 18 shows the typical Raman spectroscopy of D1500/ZrO₂ and Al₂O₃ composites when irradiated under a 532 nm laser. In the low wavenumber range of the spectrum, where usually the bands specific to the metal-molecule stretching vibration appear, they come from ZrO₂ and Al₂O₃ fillers. The overlapping peaks around 1500 cm⁻¹ and 3000 cm⁻¹ belong to the CH₃ deformation and C—H stretching peaks. As expected, all labeled CH₃ peaks disappeared at 700° C., while peaks from fillers can still be identified with changing measurement parameters. This result is consistent with the previous FTIR analysis that the coating layer may be destroyed or decomposed when annealed at 700° C.

### 3.3 Cross-Sectional Analysis

A comprehensive examination of coating/substrate interfaces was conducted through transmission electron microscopy (TEM, ThermoFisher Talos F200X). The thickness of the coating layer on the SS304 substrate was determined through cross-sectional TEM imaging of samples machined via FIB (ThermoFisher Quanta 3D FEG). TEM specimens were extracted perpendicularly to the interface utilizing a standard FIB technique. Hence, structural characterization of the coatings, coating/substrate interfaces, and elemental mapping were conducted via TEM, equipped with The SuperX Energy Dispersive Spectrometry (SuperX EDS) system.

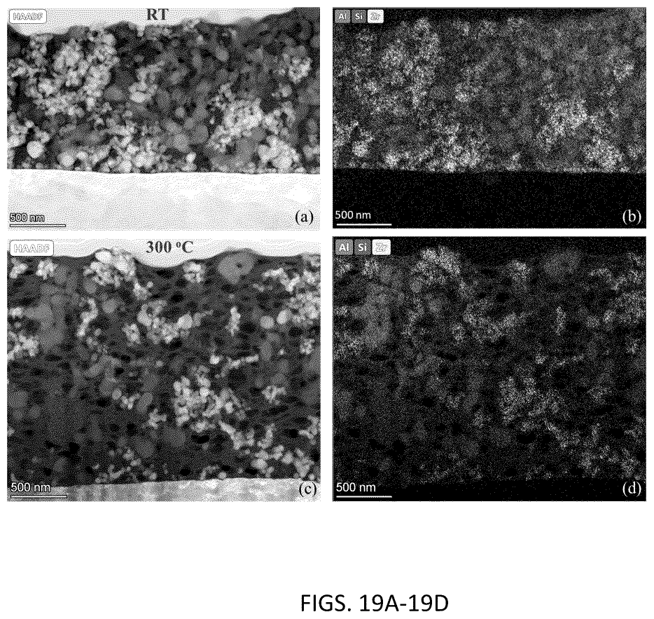

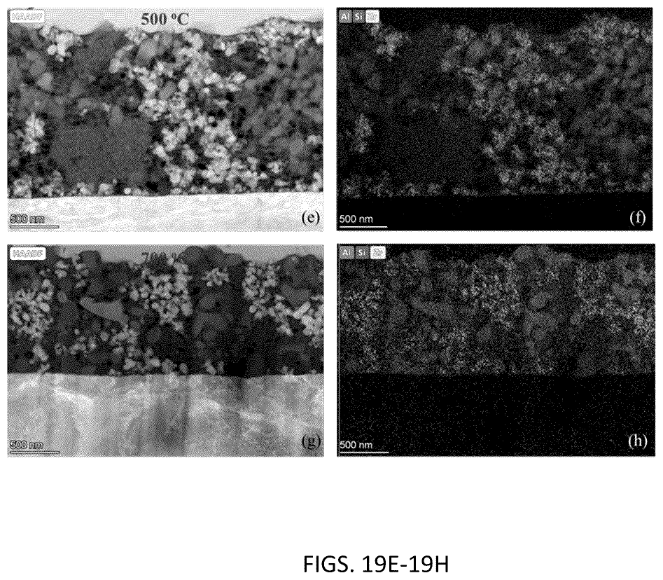

The cross-sections of the coatings produced are shown in FIGS. 19A-19H. It can be observed there is a formation of dense coating (Durazane 1500 with 50 wt % Al₂O₃ and ZrO₂ particles) on the SS304 substrate without any cracks or voids. The thickness of the coating is around 1.3 μm. The coating is well bonded to the SS304 substrate, with no indication of delamination at the interface. The cross-section TEM-EDS mapping of combined Al, Zr, and Si is depicted in FIG. 19B. Si distributes uniformly throughout the coating, leading to a spatial overlap of Al and Zr elemental maps. Furthermore, clusters of Al and Zr can be found in distinct regions. In general, both the Al₂O₃ and ZrO₂ particles are dispersed homogeneously within a dense ceramic matrix.

When the coating was annealed at 300° C., voids or bubbles can be well observed in FIGS. 19C and 19D throughout the coating. As previously stated, D1500 reacts with the moisture from the air and then releases NH₃ and H₂ based on hydrolysis and condensation reactions. The evolution of the gas formed during the polymerization suggests an incomplete curing of Durazane 1500 prior to annealing, as evidenced by the detection of a weak peak in the N—Si—N network at 910 cm⁻¹ in the FTIR spectroscopy analysis in the previous section. When the coating is subjected to annealing, the remaining unreacted groups in the coating undergo further crosslinking, resulting in the release of gas, and then the formation of bubbles. The observed increase in thickness of the 300° C. sample (2.2 μm) could be attributed to the formation of pronounced bubbles that inflated the coating. Incomplete polymerization may occur due to various factors, including insufficient curing time or temperature during the deposition and curing process.

As the annealing temperature was increased to 500° C., the presence of bubbles is still observable, albeit in reduced quantities compared to the 300° C. sample. This reduction in the number of bubbles with increasing annealing temperature can be the result of the progressive completion of the polymerization process. As the temperature increases, the remaining unreacted groups in the coating undergo further crosslinking, resulting in a denser (1.7 μm) and more homogeneous coating structure with fewer voids or bubbles. When the annealing temperature was increased to 700° C., the coating became denser (1.2 μm), and fewer bubbles were observed.

### 3.4 Contact Angle Measurement

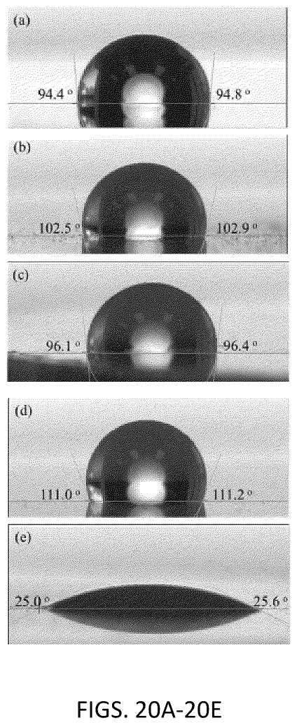

Hydrophobic property is an encouraging factor for decreasing the corrosion rate of metals, limiting their interactions with corrosive species, such as water and ions. A goniometer from FDS Corp Dataphysics OCA with a digital camera and an automatic drop dispenser was employed to determine the contact angle (θ) of 5 μL water on the coated SS304 substrate. Here we conducted repeated contact angle measurements to study the hydrophobic property of coated SS304 substrates. The contact angles of the samples were measured in multiple locations, and the average values are summarized in Table 10. Representative measurements are shown in FIGS. 20A-20E. The results indicate that both the RT sample and the samples annealed at 300° C. and 500° C. exhibit high contact angles, reaching up to 111.09°. This demonstrates the excellent water-repellent capability of the D1500 coating at annealing temperatures up to 500° C. However, the sample annealed at 700° C. shows a significantly lower contact angle of only 26.04°. This suggests that the coating layer undergoes degradation when subjected to annealing at 700° C., which is consistent with the findings from previous FTIR and Raman analysis.

TABLE 10
Contact angles of coated substrates with water
(5 μL) measured by drop-shape analysis.

| Sample | Contact Angle (°) | Error (°) |
|---|---|---|
| RT | 102.90 | 1.28 |
| 300° C. | 96.10 | 1.09 |
| 500° C. | 111.09 | 0.61 |
| 700° C. | 26.04 | 3.17 |

### 3.5 Electrochemical Measurement

The electrochemical experiments were performed to investigate the corrosion resistance of the deposited D1500 coatings annealed at varied temperatures. The setup is based on the MULTIPORT™ corrosion cell kit and Interface 1000 potentiostat from Gamry Instruments with the DC105 Electrochem software. The exposed area of our samples to MgCl₂ solution is 3.14 cm². 0.54 mol/L of MgCl₂ solution was prepared based on Magnesium chloride hexahydrate (MgCl₂-6H₂O) from Thermal Scientific and deionized water. MgCl₂ was selected as the corrosive solution since it is one of the most detrimental in austenitic stainless steel. Prior to the experiments, the solution was purged with nitrogen for 1 hour to remove the oxygen and then immersed the specimen into the MgCl₂ solution for 24 hours to obtain a stable open circuit potential based on the ASTM G61 standard. Finally, starts the potential scan at the corrosion potential with a scan rate of 0.6 V/h.

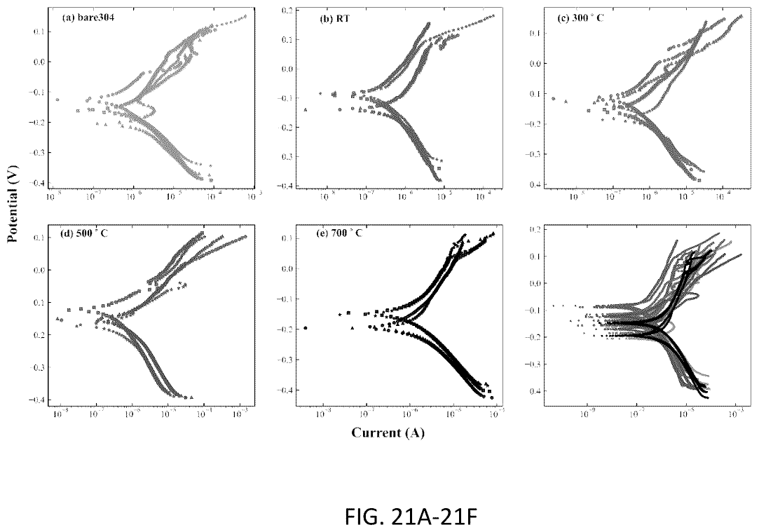

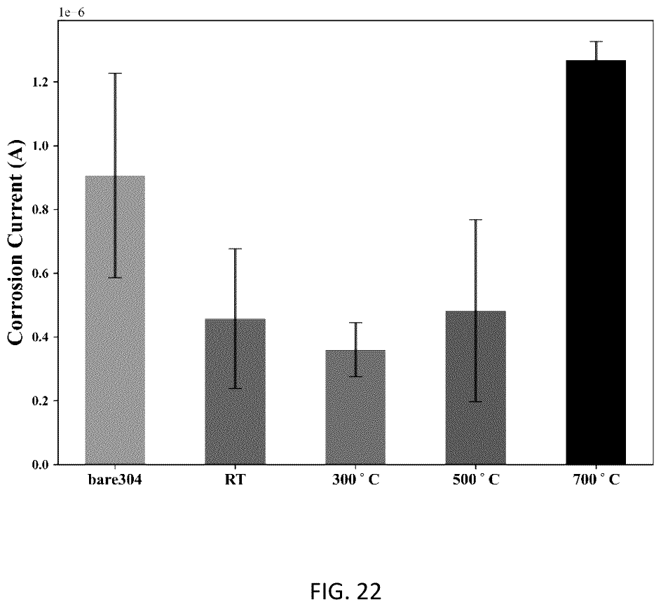

FIG. 21 shows the repeated potentiodynamic polarization plots of produced samples. The corrosion current density of these samples was presented in Table 11 and FIG. 22. The current density of Bare SS304 1.15 μA, while RT is 0.55 μA. The dramatic drop in the corrosion current density of RT could be caused by the dielectric nature of the D1500 and embedded fillers. This detected electrochemical activity might be related to the localized activity, where coatings are not intact due to the presence of cracks, micropores, or uncovered deposition. This result manifests the corrosion inhibition of D1500 coatings on SS304 substrates as a physical barrier. Furthermore, the current density reached its lowest when the annealing temperature is 300° C. It may be ascribed to the fact that annealing helps to facilitate curing status and then forms a more dense and intact coating. The current density increased a little bit but was still lower than Bare SS304 when annealed at 300° C. and 500° C. At the same time, the corrosion current density of 700° C. sample is higher than Bare SS304. This evidence could help prove that high-temperature annealing improves the curing status but compromises the D1500 coating when the temperature reaches to 500° C., and then destroys the coating at 700° C.

TABLE 11
Corrosion current density of produced samples.

| Sample | Current (μA) | Error (μA) |
|---|---|---|
| Bare SS304 | 1.15 | 0.06 |
| RT | 0.55 | 0.29 |
| 300° C. | 0.36 | 0.10 |
| 500° C. | 0.58 | 0.35 |
| 700° C. | 1.28 | 0.08 |

### CONCLUSION

In conclusion, this study aimed to develop a new-generation coating that could effectively withstand harsh environments and mitigate the limitations associated with traditional techniques for dry storage canisters containing spent nuclear fuel. This work investigated the structure evolution and corrosion resistance of D1500 coatings with 50 wt % ZrO₂ and Al₂O₃ fillers on SS304 substrates, deposited using spray coating and annealed at various temperatures. The evolution of the pre-ceramic solution into ceramics was evaluated using FTIR and Raman spectroscopy. The findings revealed that annealing promoted nearly complete hydrolysis of Durazane 1500, although coating decomposition occurred at 700° C. The presence of voids or bubbles in the annealed coatings can be attributed to incomplete curing prior to annealing. Furthermore, the coatings exhibited favorable hydrophobic properties, with a contact angle exceeding 90°, except for the sample annealed at 700° C. Samples annealed at room temperature, 300° C., and 500° C. demonstrated lower corrosion current compared to bare SS304, indicating superior corrosion resistance. In contrast, samples annealed at 700° C. exhibited the poorest corrosion inhibition due to coating degradation at high temperatures. This study validates the remarkable corrosion inhibition achieved by D1500 coatings and highlights the positive impact of annealing. Future research efforts will be directed towards optimizing annealing conditions and formulations to further enhance the coating's performance in safeguarding steel canisters from corrosion.

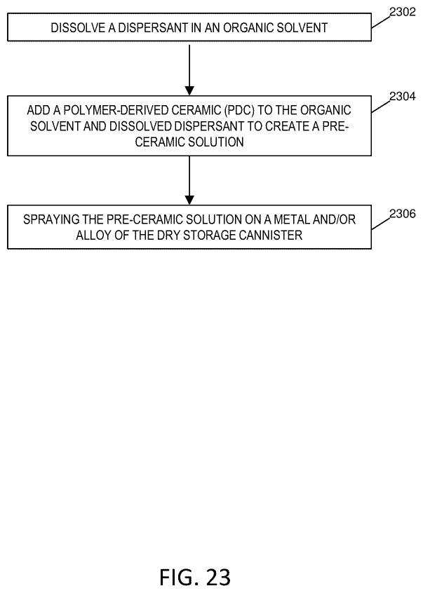

FIG. 23 is a flow chart illustrating an example method 2300 for preparing at least one protective coating on dry storage cannisters for spent nuclear fuel and waste. Referring to FIG. 23, in step 2302, a dispersant is dissolved in an organic solvent. Examples of the organic solvent can include esters, ethers, aromates, and/or ketones.

In step 2304, a polymer-derived ceramic (PDC) is added to the organic solvent and dissolved dispersant to create a pre-ceramic solution. One or more metal oxides can also be added to the organic solvent and dissolved dispersant. The metal oxide can include zirconium oxide, aluminum oxide, titanium oxide, and/or iron oxide comprising nanoparticles and/or microparticles. The PDC can include organopolysilazane (OPSZ), such as for example Durazane 1500 or Durazane 1800. One or more passive fillers, active fillers, and/or glass or sacrificial fillers including nanoparticles and/or microparticles can be added to the organic solvent and dissolved dispersant. The glass or sacrificial fillers can be mostly organic compounds. The one or more passive fillers can include SiC, Si₃N₄, Al₂O₃, ZrO₂, and/or TiO₂. The one or more active fillers can include ZrSi₂, TiSi₂, and/or C.

In step 2306, the pre-ceramic solution is sprayed on a metal and/or alloy of the dry storage cannisters. The metal and/or alloy can be post-heated and/or pre-heated at different temperatures to improve anti-corrosion performance. The pre-ceramic solution can be sprayed onto the metal and/or alloy in a humid environment to enhance the curing process. The pre-ceramic solution can be applied on the metal and/or alloy using ultrasonic coating, air spraying, brushing, airless spraying, or aerosolizing to facilitate uniform distribution of the pre-ceramic solution. The coated metal and/or alloy can be post-heated and/or pre-heated at different temperatures to improve coating adhesion and/or anti-corrosion performance.

In addition to dry storage containers, the method illustrated in FIG. 23 is also applicable to any metal and/or metal alloy surfaces exposed to harsh environmental conditions, including but not limited to materials, components and structures used in marine environments, and oil and gas extraction, processing, and transportation equipment and components. The coating prepared as described herein can provide enhanced protection against environmental corrosion, chemical exposure, ultraviolet (UV) exposure, extreme temperatures, and mechanical wear.

In addition to ultrasonic coating, air spraying, brushing, airless spraying, or aerosolizing, other coating approaches or mechanisms can be used. Such methods include dip coating, spin coating, brush/roller coating applications, or other physical deposition or chemical deposition approaches, to facilitate uniform distribution of the pre-ceramic solution.

Although the studies described above relate primarily to coating stainless steel articles, the subject matter described herein is not limited to applying the pre-ceramic coating to stainless steel articles. Examples of other materials and substrates to which the pre-ceramic coating(s) can be applied include aluminum, titanium, other high-performance metals or alloys, or non-metallic materials.

The method here is applicable to different types of organic coatings, inorganic coatings, hybrid coatings, including but not limited to high entropy coatings.

The methodology described herein can be used to apply the pre-ceramic coating to industrial articles with varying surface topologies, including flat surfaces, curved surfaces, and surfaces with regular or irregular surface topologies.

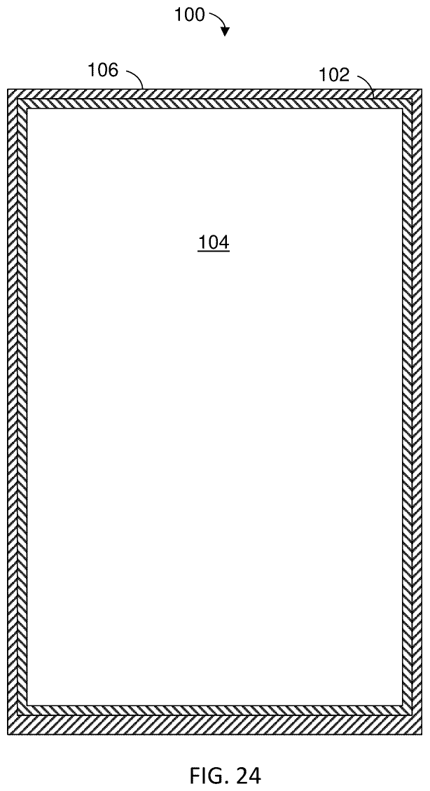

FIG. 24 is a diagram of an industrial article, such as a dry storage cannister for spent nuclear fuel and/or other waste, where the article is coated with a ceramic coating, or multiple layers of coatings, formulated and applied using the methodology described herein. Referring to FIG. 24, an industrial article 100 includes at least one wall 102 that forms a housing, which defines an interior region or enclosure 104. Wall 102 may be formed of a metal or a metal alloy. Industrial article 100 further includes a ceramic coating 106 located on an exterior surface of wall 102. Ceramic coating 106 may include a dispersant dissolved in an organic solvent and a polymer-derived ceramic (PDC) mixed with the organic solvent and the dissolved dispersant to create a diluted pre-ceramic solution. Ceramic coating 106 may be created and applied using the methodologies and materials described above. In one example, wall 102 may be the sidewall, and industrial article 100 may be a DSC, a pipe, or any structure that functions as a channel or a container for solids, liquids, and/or gases, including hazardous and non-hazardous materials.

The disclosure of each of the following references is incorporated herein by reference in its entirety.

### REFERENCES

[1]. Ewing, Rodney C. “Long-term storage of spent nuclear fuel.” Nature Materials 14, no. 3 (2015): 252.
[2]. N. Tsoulfanidis and R. G. Cochran, “Radioactive Waste Management,” Nucl. Technol., vol. 93, pp. 263-304, 1991.
[3]. Xie, Y., & Zhang, J. (2015). Chloride-induced stress corrosion cracking of used nuclear fuel welded stainless steel canisters: A review. Journal of Nuclear Materials, 466, 85-93.
[4]. Gorman, J., Fuhr, K., & Broussard, J. (2014). Literature Review of Environmental Conditions and Chloride-Induced Degradation Relevant to Stainless Steel Canisters in Dry Cask Storage Systems. EPRI-3002002528, Palo Alto, CA: EPRI.
[5]. Mayuzumi, M., Tani, J., & Arai, T. (2008). Chloride induced stress corrosion cracking of candidate canister materials for dry storage of spent fuel. Nuclear Engineering and Design, 238(5), 1227-1232.
[6]. P. Peyre, X. Scherpereel, L. Berthe, C. Carboni, R. Fabbro, G. Beranger, C. Lemaitre, Surface modifications induced in 316L steel by laser peening and shot-peening. Influence on pitting corrosion resistance, Mater. Sci. Eng.: A 280 (2000) 294-302.
[7]. Xinlong Wei, Chao Zhang, Xiang Ling, Effects of laser shock processing on corrosion resistance of AISI 304 stainless steel in acid chloride solution, J Alloy Compd, 723 (2017) 237-242.
[8]. Pandu Sunil Kumar, Swati Ghosh Acharyya, S. V. Ramana Rao, Komal Kapoor, Surface buffing and its effect on chloride induced SCC of 304L austenitic stainless steel, 2018 IOP Conf. Ser.: Mater. Sci. Eng. 314 012002.
[9]. Parrott, R., Pitts, H., & Hill, H. D. (2011). Chloride stress corrosion cracking in austenitic stainless steel. The Health and Safety Laboratory for the Health and Safety Executive: Buxton, UK.
[10]. Hodder, K. J., Izadi, H., McDonald, A. G., & Gerlich, A. P. (2012). Fabrication of aluminum-alumina metal matrix composites via cold gas dynamic spraying at low pressure followed by friction stir processing. Materials Science and Engineering: A, 556, 114-121.
[11]. Yeom, H., Dabney, T., Pocquette, N., Ross, K., Pfefferkorn, F. E., & Sridharan, K. (2020). Cold spray deposition of 304L stainless steel to mitigate chloride-induced stress corrosion cracking in canisters for used nuclear fuel storage. Journal of Nuclear Materials, 538, 152254.
[12]. Fusco, Michael. “Multilayer Protective Coatings for High-Level Nuclear Waste Storage Containers.” (2016).
[13]. Colombo, P., Mera, G., Riedel, R., & Soraru, G. D. (2010). Polymer-derived ceramics: 40 years of research and innovation in advanced ceramics. Journal of the American Ceramic Society, 93(7), 1805-1837.
[14]. Barroso, G., Li, Q., Bordia, R. K., & Motz, G. (2019). Polymeric and ceramic silicon-based coatings—a review. Journal of materials chemistry A, 7(5), 1936-1963.
[15]. Greil, P. (1995). Active-filler-controlled pyrolysis of preceramic polymers. Journal of the American Ceramic Society, 78(4), 835-848.
[16]. Torrey, J. D., & Bordia, R. K. (2008). Processing of polymer-derived ceramic composite coatings on steel. Journal of the American Ceramic Society, 91(1), 41-45.
[17]. Torrey, J. D., Bordia, R. K., Henager, C. H., Blum, Y., Shin, Y., & Samuels, W. D. (2006). Composite polymer-derived ceramic system for oxidizing environments. Journal of materials science, 41(14), 4617-4622.
[18]. Günthner, M., Schütz, A., Glatzel, U., Wang, K., Bordia, R. K., Greißl, O., . . . & Motz, G. (2011). High performance environmental barrier coatings, Part I: Passive filler loaded SiCN system for steel. Journal of the European Ceramic Society, 31(15), 3003-3010.
[19]. Günthner, M., Kraus, T., Krenkel, W., Motz, G., Dierdorf, A., & Decker, D. (2009). Particle-filled PHPS silazane-based coatings on steel. International Journal of Applied Ceramic Technology, 6(3), 373-380.
[20]. Lukacs III, A., & Knasiak, G. J. (2003). U.S. Pat. No. 6,652,978. Washington, DC: U.S. Patent and Trademark Office.
[21]. Rossi, S., Deflorian, F., & Fedel, M. (2019). Polysilazane-based coatings: corrosion protection and anti-graffiti properties. Surface Engineering, 35(4), 343-350.
[22]. Fedel, M., Rodríguez Gómez, F. J., Rossi, S., & Deflorian, F. (2019). Characterization of polyorganosilazane-derived hybrid coatings for the corrosion protection of mild steel in chloride solution. Coatings, 9(10), 680.
[23]. Furtat, P., Lenz-Leite, M., Ionescu, E., Machado, R. A. F., & Motz, G. (2017). Synthesis of fluorine-modified polysilazanes via Si—H bond activation and their application as protective hydrophobic coatings. Journal of Materials Chemistry A, 5(48), 25509-25521.
[24]. Zhan, Y., Grottenmüller, R., Li, W., Javaid, F., & Riedel, R. (2021). Evaluation of mechanical properties and hydrophobicity of room-temperature, moisture-curable polysilazane coatings. Journal of Applied Polymer Science, 138(21), 50469.
[25]. Fedel, M., Rossi, S., & Deflorian, F. (2019). Polymethyl (hydro)/polydimethylsilazane-derived coatings applied on AA1050: Effect of the dilution in butyl acetate on the structural and electrochemical properties. Journal of Coatings Technology and Research, 16(4), 1013-1019.
[26]. Girotto, C., Rand, B. P., Genoe, J., & Heremans, P. (2009). Exploring spray coating as a deposition technique for the fabrication of solution-processed solar cells. Solar energy materials and solar cells, 93(4), 454-458.
[27]. Aziz, F., & Ismail, A. F. (2015). Spray coating methods for polymer solar cells fabrication: A review. Materials Science in Semiconductor Processing, 39, 416-425.
[28]. Hernández-Rodríguez, P., & López-Honorato, E. (2017). Polymer derived SiC environmental barrier coatings with superwetting properties. Ceramics International, 43(14), 11289-11295.
[29]. Yang, C., Tartaglino, U., & Persson, B. N. J. (2006). Influence of surface roughness on superhydrophobicity. Physical review letters, 97(11), 116103.
[30]. El Hadri, M., Achahbar, A., El Khamkhami, J., Khelifa, B., Faivre, V., Cong, T. T., . . . & Bresson, S. (2013). Raman spectroscopy investigation of mono- and diacyl-polyoxyethylene glycols. Vibrational Spectroscopy, 64, 78-88.
[31]. Ferrari, A. C., & Robertson, J. (2001). Resonant Raman spectroscopy of disordered, amorphous, and diamondlike carbon. Physical review B, 64(7), 075414.
[32]. Xu, Z., He, Z., Song, Y., Fu, X., Rommel, M., Luo, X., . . . & Fang, F. (2018). Topic review: Application of raman spectroscopy characterization in micro/nano-machining. Micromachines, 9(7), 361.
[33]. George, J., Hsu, C. C., Nguyen, L. T. B., Ye, H., & Cui, Z. (2020). Neural tissue engineering with structured hydrogels in CNS models and therapies. Biotechnology advances, 42, 107370.
[34]. Constantinides, G., Chandran, K. R., Ulm, F. J., & Van Vliet, K. J. (2006). Grid indentation analysis of composite microstructure and mechanics: Principles and validation. Materials Science and Engineering: A, 430(1-2), 189-202.
[35]. Prosek, T., Iversen, A., & Taxen, C. (2008). Low temperature stress corrosion cracking of stainless steels in the atmosphere in presence of chloride deposits. In CORROSION 2008. OnePetro.
[36]. Örnek, C., & Engelberg, D. L. (2019). Toward understanding the effects of strain and chloride deposition density on atmospheric chloride-induced stress corrosion cracking of type 304 austenitic stainless steel under MgCl₂ and FeCl₃: MgCl₂ droplets. Corrosion, 75(2), 167-182.
[37]. Harston, J. D., & Scully, J. C. (1970). Fractographic Observations on the Stress Corrosion Cracking of Some Austenitic Stainless Steels in MgCl₂ Solutions at 154 C. Corrosion, 26(9), 387-395.
[38]. ASTM Subcommittee F-4.15 on Material Test Methods. (2019). Standard Test Method for Conducting Cyclic Potentiodynamic Polarization Measurements to Determine the Corrosion Susceptibility of Small Implant Devices. ASTM International.
[39]. Konovalova, V. (2021). The effect of temperature on the corrosion rate of iron-carbon alloys. Materials Today: Proceedings, 38, 1326-1329.
[40]. Perissi, I., Bardi, U., Caporali, S., & Lavacchi, A. (2006). High temperature corrosion properties of ionic liquids. Corrosion science, 48(9), 2349-2362.
[41]. Cao, M., Liu, L., Fan, L., Yu, Z., Li, Y., Oguzie, E. E., & Wang, F. (2018). Influence of temperature on corrosion behavior of 2A02 Al alloy in marine atmospheric environments. Materials, 11(2), 235.
[42]. Fusco, M. A., Ay, Y., Casey, A. H., Bourham, M. A., & Winfrey, A. L, “Corrosion of single layer thin film protective coatings on steel substrates for high level waste container,” Progress in Nuclear Energy, 89, 159-169 (2016).
[43]. Padture, N. P, “Advanced structural ceramics in aerospace propulsion,” Nature materials, 15(8), 804 (2016).
[44]. Rathod, V. T., Kumar, J. S., & Jain, A, “Polymer and ceramic nanocomposites for aerospace applications,” Applied Nanoscience, 7(8), 519-548 (2017).
[45]. Naslain, R., Guette, A., Rebillat, F., Pailler, R., Langlais, F., & Bourrat, X, “Boron-bearing species in ceramic matrix composites for long-term aerospace applications,” Journal of Solid State Chemistry, 177(2), 449-456 (2004).
[46]. Koyanagi, T., Katoh, Y., Singh, G., & Snead, M. “SiC/SiC cladding materials properties handbook,” ORNL/TM-2017/385, Oakridge National Laboratory (2017).
[47]. Wang, P., Zhang, X., Wang, Z., Chen, T., Zhang, H., Duan, W., & Han, H, “A Robust Superhydrophobic Smart Coating with Reversible Thermochromic and Photochromic Property,” Journal of Bionic Engineering, 19(6), 1589-1600 (2022).
[48]. Maia, F., Yasakau, K. A., Carneiro, J., Kallip, S., Tediru, J., Henriques, T., & Ferreira, M. G. S, “Corrosion protection of AA.2024 by sol-gel coatings modified with MET-loaded polyurea microcapsules,” Chemical Engineering Journal, 283, 1108-1117 (2016).

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for preparing and using at least one protective coating on dry storage cannisters for spent nuclear fuel and/or other waste, the method comprising:
dissolving a dispersant in an organic solvent;
adding a polymer-derived ceramic (PDC) to the organic solvent and dissolved dispersant to create a diluted pre-ceramic solution; and
applying the pre-ceramic solution on a metal and/or alloy of at least one of dry storage cannisters.

2. The method of claim 1 comprising adding one or more metal oxides to the organic solvent and dissolved dispersant.

3. The method of claim 2 wherein the one or more metal oxides comprise zirconium oxide, aluminum oxide, titanium oxide, and/or iron oxide comprising nanoparticles and/or microparticles.

4. The method of claim 1 comprising adding one or more passive fillers, active fillers, and/or glass or sacrificial fillers comprising nanoparticles and/or microparticles to the organic solvent and dissolved dispersant.

5. The method of claim 4 comprising adding one or more passive fillers comprising nanoparticles and/or microparticles to the organic solvent and dissolved dispersant, wherein the one or more passive fillers comprise SiC, Si₃N₄, Al₂O₃, ZrO₂, and/or TiO₂.

6. The method of claim 4 comprising adding one or more active fillers comprising nanoparticles and/or microparticles to the organic solvent and dissolved dispersant, wherein the one or more active fillers comprise ZrSi₂, TiSi₂, and/or C.

7. The method of claim 1 wherein the PDC comprises organopolysilazane (OPSZ).

8. The method of claim 7 wherein the OPSZ comprises Durazane 1500 or Durazane 1800.

9. The method of claim 1 comprising post-heating and/or pre-heating the coated metal and/or alloy at different temperatures to improve coating adhesion and/or anti-corrosion performance.

10. The method of claim 1 comprising spraying the pre-ceramic solution on the metal and/or alloy in a humid environment to enhance curing of the pre-ceramic solution.

11. The method of claim 1 wherein applying the pre-ceramic solution on the metal and/or alloy comprises using ultrasonic coating, air spraying, brushing, airless spraying, aerosolizing, or other physical deposition or chemical deposition approaches, to facilitate uniform distribution of the pre-ceramic solution.

12. The method of claim 1 wherein the organic solvent comprises esters, ethers, aromates, and/or ketones.

13. An industrial article comprising:
at least one wall having an exterior surface; and
a ceramic coating located on the exterior surface, wherein the ceramic coating comprises a dispersant dissolved in an organic solvent and a polymer-derived ceramic (PDC) mixed with the organic solvent and the dissolved dispersant to create a diluted pre-ceramic solution for coating.

14. The industrial article of claim 13 wherein the ceramic coating comprises one or more metal oxides.

15. The industrial article of claim 14 wherein the one or more metal oxides comprise zirconium oxide, aluminum oxide, titanium oxide, and/or iron oxide comprising nanoparticles and/or microparticles.

16. The industrial article of claim 13 wherein the ceramic coating comprises one or more passive fillers, active fillers, and/or glass or sacrificial fillers comprising nanoparticles and/or microparticles.

17. The industrial article of claim 16 wherein the ceramic coating comprises the one or more passive fillers and the one or more passive fillers comprise SiC, Si₃N₄, Al₂O₃, ZrO₂, and/or TiO₂.

18. The industrial article of claim 13 wherein the ceramic coating comprises one or more active fillers comprising nanoparticles and/or microparticles to the organic solvent and dissolved dispersant, wherein one or more active fillers comprise ZrSi₂, TiSi₂, and/or C.

19. The industrial article of claim 13 wherein at least one wall comprises a metal, a metal alloy, or a non-metallic material.

20. The industrial article of claim 13 wherein the exterior surface includes at least one of a flat surface topology, a curved surface topology, a regular surface topology, and an irregular surface topology.

21. The industrial article of claim 13 wherein the PDC comprises organopolysilazane (OPSZ).

22. The industrial article of claim 21 wherein the OPSZ comprises Durazane 1500 or Durazane 1800.

23. The industrial article of claim 13 wherein the organic solvent comprises esters, ethers, aromates, and/or ketones.

24. The industrial article of claim 13 wherein at least one wall comprises a sidewall forming an enclosure for housing a hazardous material.

25. The industrial article of claim 13 wherein at least one wall comprises a sidewall forming a housing or a channel for a solid, a liquid, and/or a gas.

26. The industrial article of claim 13 wherein the ceramic coating is configured to protect the exterior surface from corrosion in a marine environment.
